(19) United States
(12) Patent Application Publication
(10) Pub. No.: US 2015/0173312 A1
(43) Pub. Date: Jun. 25, 2015

(54) MODULAR INTERGRATED SYSTEM FOR SEED GERMINATION, CULTIVATION, PLANTING, FERTILIZING AND MAINTENANCE OF PLANTS

(71) Applicant: QUIZCAMP-FABRICO E COMERCIO DE PRODUTOS ALIMENTARES, S.A., Lisboa (PT)

(72) Inventor: Manuel Maria Rodrigues, Carnaxide (PT)

(73) Assignee: QUIZCAMP-FABRICO E COMERCIO DE PRODUTOS ALIMENTARES, S.A., Lisboa (PT)

(21) Appl. No.: 14/390,156

(22) PCT Filed: Apr. 3, 2013
(86) PCT No.: PCT/PT2013/000020

§ 371 Date: Oct. 2, 2014

(30) Foreign Application Priority Data
Apr. 3, 2012 (PT) 106236

(51) Int. Cl. A01G 27/00

(52) U.S. Cl. CPC A01G 27/005

(57) ABSTRACT

A modular integrated plant system having has a liquid receiver (2) with a dosing element (3) comprising two holes, respectively, one for the passage of an air feeding tube (5) to the receiver (2) and another (6) for discharge of liquid from the receiver (2) under the action of gravity. A watertight platform (4) contains liquid from the receiver. Water flows from the receiver (2) due to a difference in height between the feeding tube (5) and the discharge tube (6), only if the water level in platform (4) is lower than the length of tube (5). An absorbing cloth is at the bottom of the component (4). A drainage means (9) removes the excess water from the platform (4), and aerating means (10) for the platform (4) has of holes positioned above the water line.

### SCOPE OF THE INVENTION

This invention relates to a modular integrated system aimed at cultivating, planting, fertilizing and promoting the maintenance of plants.

More particularly, this invention relates to the so-called and currently well-known urban farms, enabling their users to practice gardening and agriculture with several plant species in urban spaces.

The modular integrated system disclosed in this invention is also designed to be used in a more intensive way, namely as plant nurseries and/or for the breeding of other plant varieties.

### PRIOR ART

Several devices are already known in the art which allow gardening and agriculture of different plant species to be practiced in urban spaces.

These devices include the one disclosed in the international patent application PCT WO2007084020. In effect, it relates to a modular container system which is appropriate for growing plant varieties but which, per se, does not provide an irrigation system, the latter being essential to the good progress of any process aimed at cultivating and maintaining plants.

Other modules for growing and maintenance such as plant stands, different types of flower pots and similar products are commonly used for the above mentioned purposes. However, these also lack an integrated irrigation system.

Obviously, the existing systems can be provided with an independent irrigation system. However, those systems show some complexity, in addition to being expensive and subject to failure.

### SUMMARY OF THE INVENTION

This invention discloses a modular integrated system aimed at cultivating, planting, fertilizing and promoting the maintenance of plants according to claim 1. Preferred characteristics of the invention are also provided according to the dependent claims.

Therefore, one objective of the invention is to conceive a modular integrated system aimed at cultivating, planting, fertilizing and promoting the maintenance of plants, which comprises an irrigation system whose fundamental characteristics are the following:
a liquid receiver which includes a dosing element comprising two holes, respectively, one for the passage of the air feeding tube to the receiver and another for the discharge of liquid from the receiver under the action of gravity,
a watertight platform for containing liquid and which is supplied by the said liquid receiver;

wherein the regulation of the water flow from the receiver is dictated by the difference of height between the air feeding tube to the receiver and the tube for the discharge of liquid under the action of gravity, i.e. the water will be discharged only and if the water level in the platform is lower than the length of the tube;
at least one component for fitting the liquid receiver and/or for fitting at least one plant container;
an absorbing cloth at the bottom of the component;
drainage means for removing the excess water from the platform; and
aerating means for the platform comprised of holes positioned above the water line.

Further benefits, characteristics and particulars of the invention will become clearer from the following description as regards the preferred embodiments, as well as by reference to the drawings, which are provided only for explanatory purposes and should not be restrictively construed.

### BRIEF DESCRIPTION OF THE DRAWINGS

The following description is made with reference to the enclosed figures, which are given for illustrative purposes only and without any limiting character, wherein:

FIG. 1 is a perspective view of the preferred embodiment of the modular system with the three main parts disassembled;

FIG. 2 is a perspective view of the embodiment shown in FIG. 1 but with all the parts duly assembled;

FIGS. 3a, b and c are raised and perspective views, respectively, from the top and underneath the dosing element of the system which is the object of the invention;

FIGS. 4a, b, c and d are, respectively, perspective view, plan view, cross-sectional view taken along the line BB, and exploded view, of another embodiment of the invention;

FIGS. 5 to 15 are views which illustrate the embodiments of the invention.

### DETAILED DESCRIPTION OF THE INVENTION

As shown in the drawings, the modular integrated system (1) for seeds germination, cultivation, planting, fertilizing and maintenance of plants, is comprised of:
a liquid receiver (2) which includes a dosing element (3) comprising two holes, respectively, one for the passage of the air feeding tube (5) to the receiver (2) and another one (6) for the discharge of liquid from the receiver (2) under the action of gravity,
a watertight platform (4) for containing liquid and which is supplied by the said liquid receiver;

wherein the regulation of the water flow from the receiver (2) is dictated by the difference in height between the air feeding tube (5) to the receiver and the tube (6) for the discharge of liquid under the action of gravity, i.e. the water will be discharged from the receiver (2) only and if the water level in the platform (4) is lower than the length of the tube (5);
at least one component (7) for fitting the liquid receiver (2) and/or for fitting at least one plant container;
an absorbing cloth at the bottom of the component (4);
drainage means (9) for removing the excess water from the platform (4); and
aerating means (10) for the platform (4) being comprised of holes positioned above the water line.

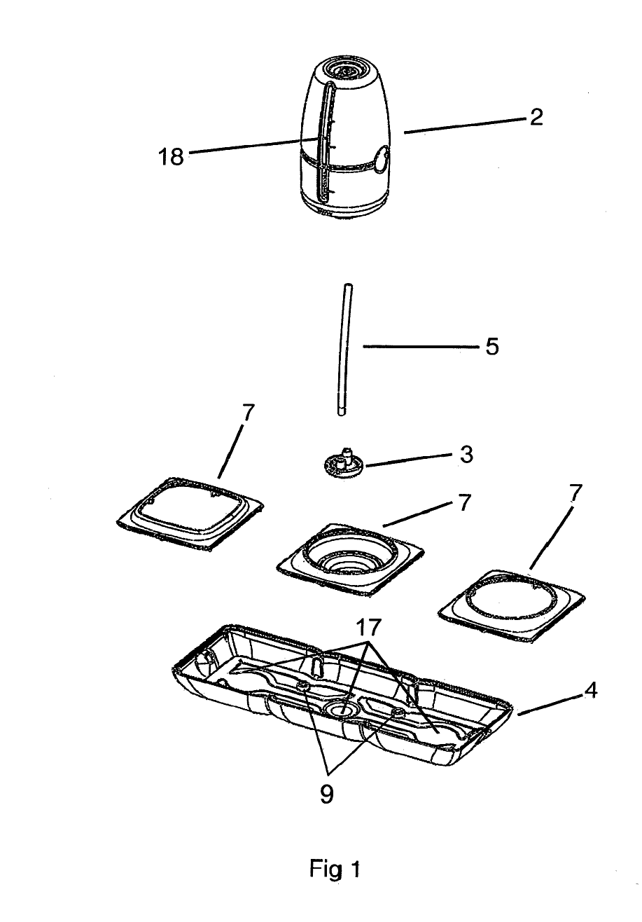

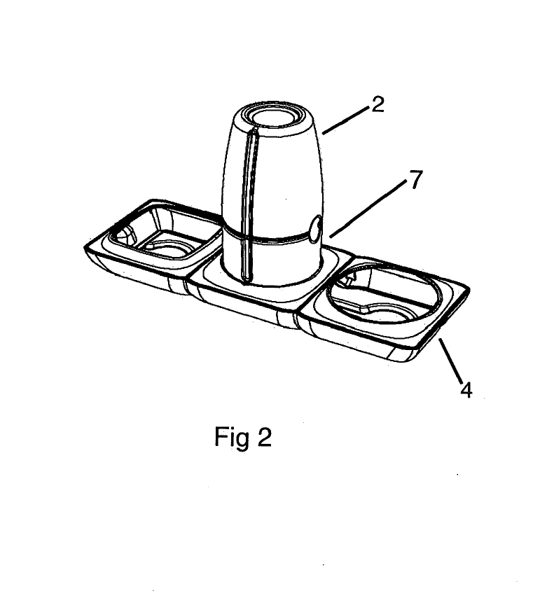

The simplest embodiment of the system which the object of the invention is depicted in FIGS. 1 and 2. Some of the aforementioned components are shown therein. It can also be noted that the bottom of the platform (4) is provided with channels and areas (17) that collect the water coming from the receiver and over which is placed an absorbing cloth (non-illustrated in the drawings).

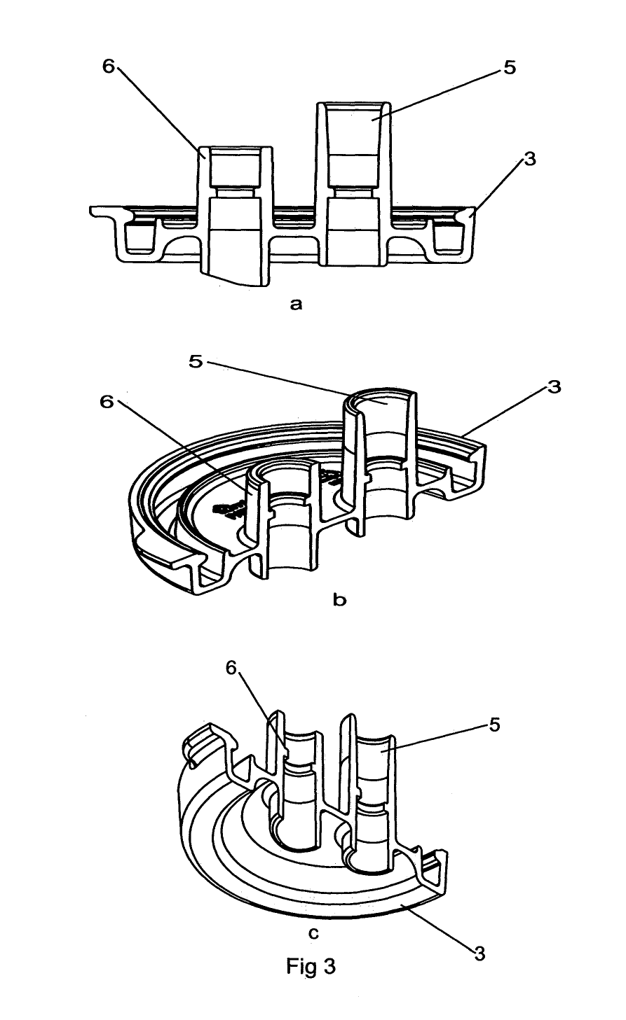

As shown in FIG. 3, the tubes (5) and (6) are an integral part of the dosing element (3). In the said element (3), the tube (5) has a greater length than the tube (6). The tube (6) for discharge of the liquid under the action of gravity has its lower end bevelled in order to create a higher surface tension and consequently causing its operation to be easier. The different length of the tubes (5, 6), both above and under the base of the dosing element (3), will ensure the regulation and control of the liquid flow from the receiver (2). This flow is controlled by the difference in height between the air feeding tube (5) to the receiver and the tube (6) for the discharge of liquid under the action of gravity, i.e., the water will be discharged from the receiver (2) only and if the water level in the platform (4) is lower than the length of the tube (5);

As shown in FIG. 1, the liquid receiver (2) can be removable. In this specific case, the cover of the removable receiver (2), which obviously works in the inverted position so as to fulfil its role, is comprised of the dosing element (3). As can be observed on the enclosed drawings, the removable receiver (2) may be undifferentiatedly fitted to any of the three parts (7).

Each one of the components (3) can be provided with an upper part (22), forming a whole with it and allowing a more specific use as regards the cultivation of plants. Also, the said components (3), with or without the upper part (22), can be put together thus forming a single unit (21).

The said removable receiver (2), as illustrated in the figures, can be provided with a vertical window (18) in order to allow its liquid level to be read. The receiver can also be provided with a cover (non-illustrated) having a vertical window as well, which is overlapped with the vertical window (18) so that the liquid level inside the receiver (2) can be read.

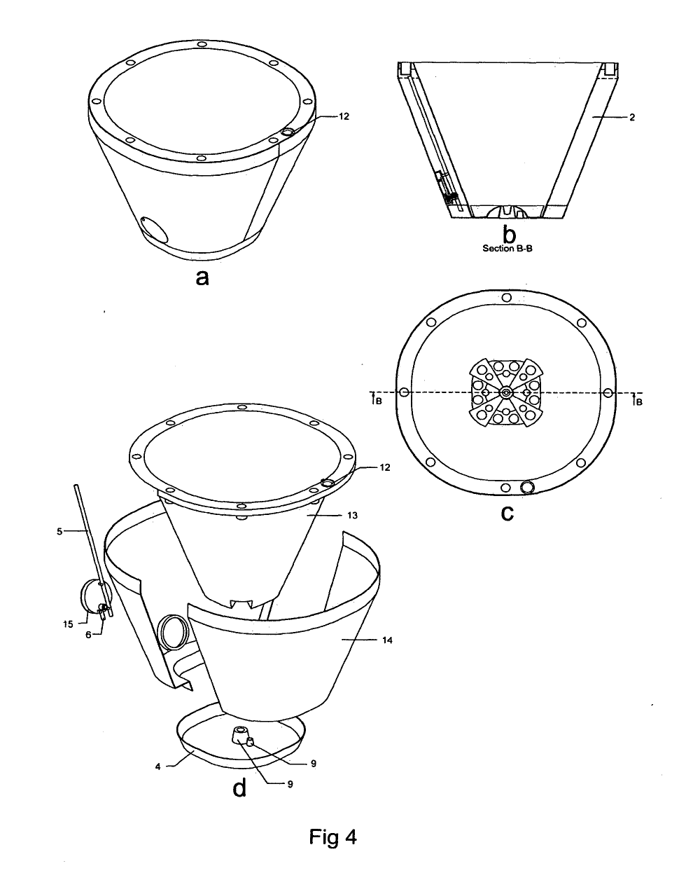

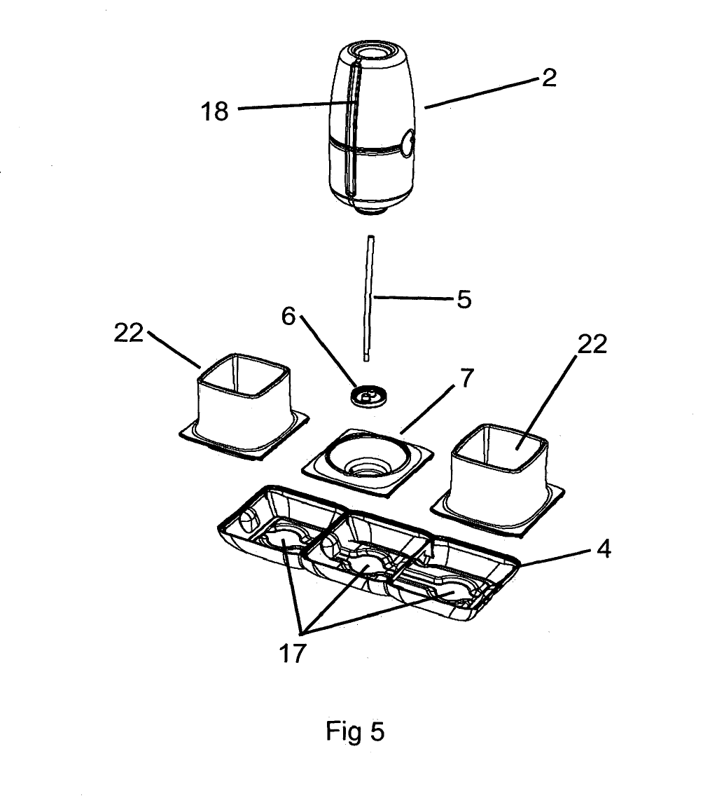

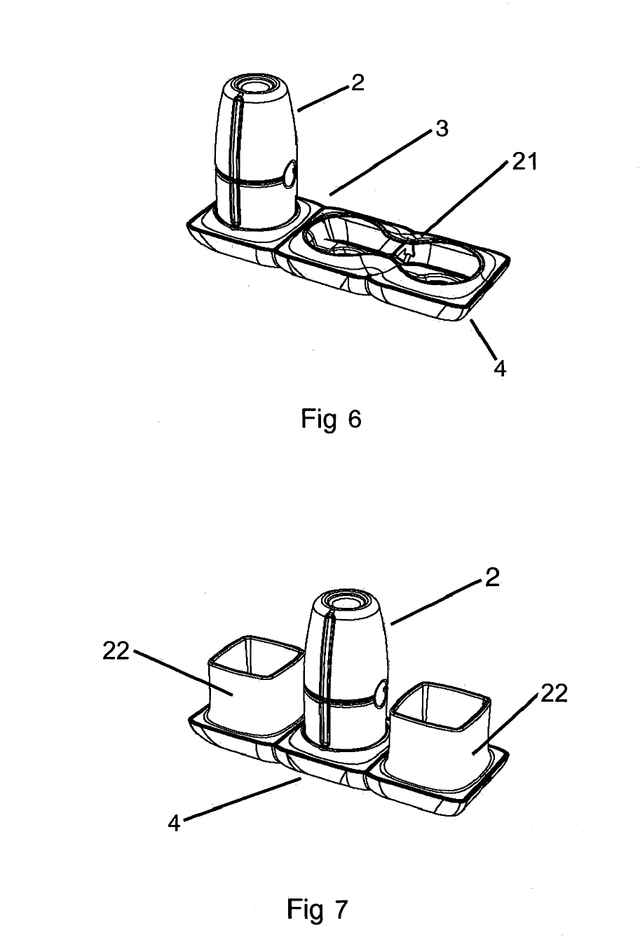

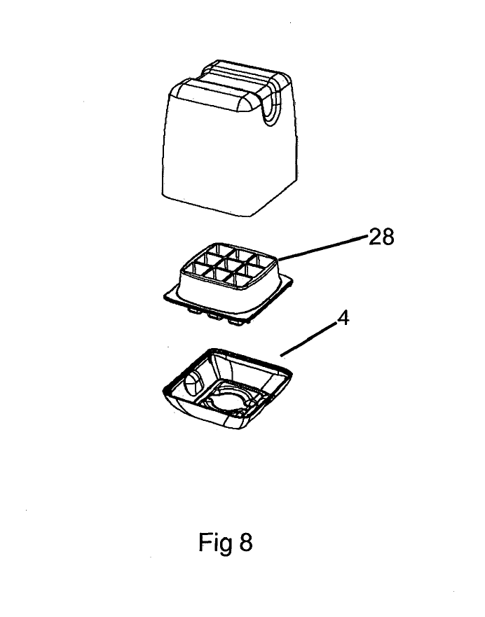

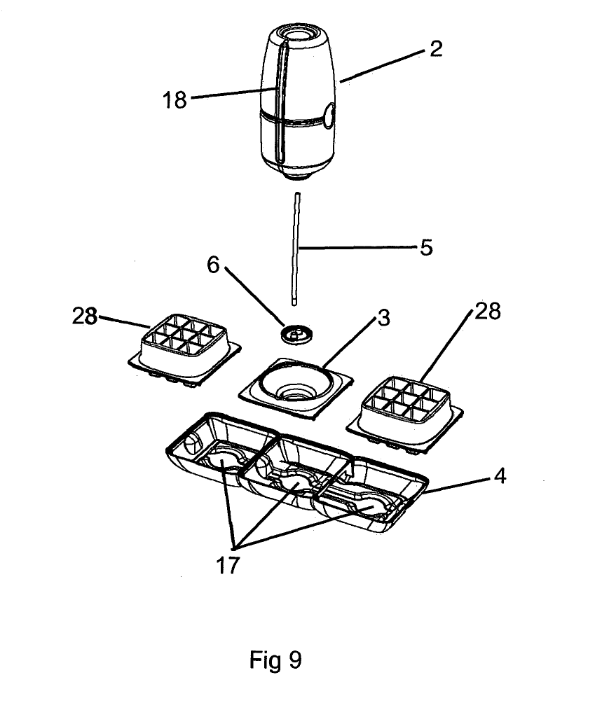

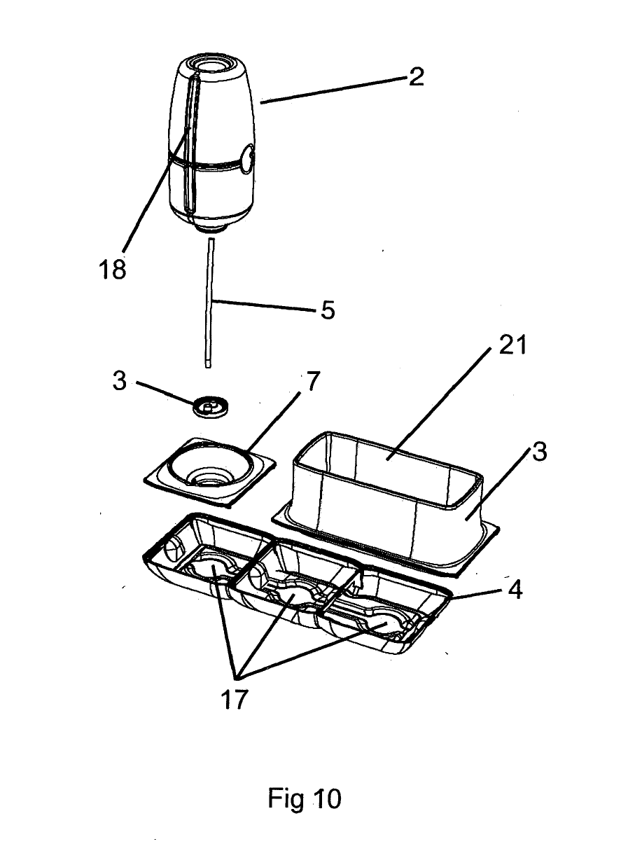

According to another embodiment of this invention, the liquid receiver is not removable, being instead an integral part of the plants container which is generally represented with reference (11). As can be observed in the FIG. 4, the aforementioned container (11) comprises an inner wall (13) and an outer wall (14), with the liquid receiver (2) being positioned in the space between those two walls. In this embodiment, the receiver (2) is provided with a filling nozzle (12) and, just like in the remaining embodiments, also with a tube (5) for air circulation and a tube (6) for liquid discharge. This embodiment of the invention, in which the liquid receiver is an integral part of the container (11), has also coupled an electronic box (15) which comprises all the devices allowing to regulate the liquid flow from the receiver (2) (i.e. the tubes (5, 6)) and warning means indicating when the liquid volume has reached its minimum level (for instance with light- or sound-emitting devices). The said box is also provided with level sensors and micro valves and eventually other devices such as, for example, mini solar panel, battery, telephone SIM card, etc. Other components of this embodiment will be mentioned hereinafter.

As can be observed in the figures, the system includes drainage means (9) for removing the excess water from the platform (4). The said means are comprised of, at least, a tubular bounce which opens outwards, projecting upwards from the bottom of the platform (4), and whose height determines the maximum level of water in the above mentioned platform (4).

In the said platform (4) there is a side groove (19) for the passage of a tube (20) with an absorbing cloth which is connected to another platform (4) in order to promote the transfer of liquid. Therefore, a liquid receiver (2) is able to supply more than one platform (4), thus ensuring the liquid supply to several containers with plants.

The platform (4) and the components (7), with or without the upper part, have a configuration whose shape is always suitable for assembling the latter into the platform. Each one of the components (7) has preferably a conic shape with a hole at its lower end.

The part (22) of the component (7) is provided with funnelled elements (23) developing downwards and a hole in the lower end for the platform (4), the said elements carrying an absorbing cloth (24) which is I-shaped, having upper flaps in the component (3) and lower flaps in the platform (4).

The component (21 or 22) can include cavities for germination (28).

In order to allow containers of different sizes to be fitted, diameter reducers were envisaged for the component (7), which in their turn will fit into the relevant holes (non-illustrated).

The components of the system which is the object of this invention are manufactured in moldable material.

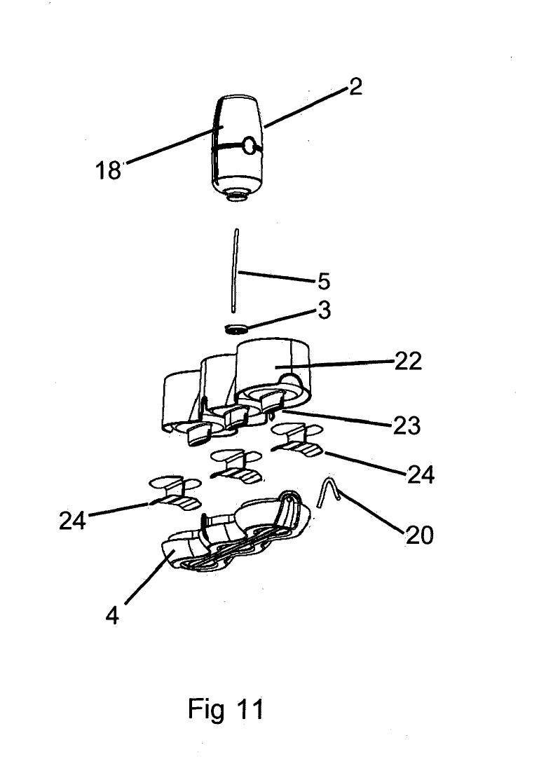

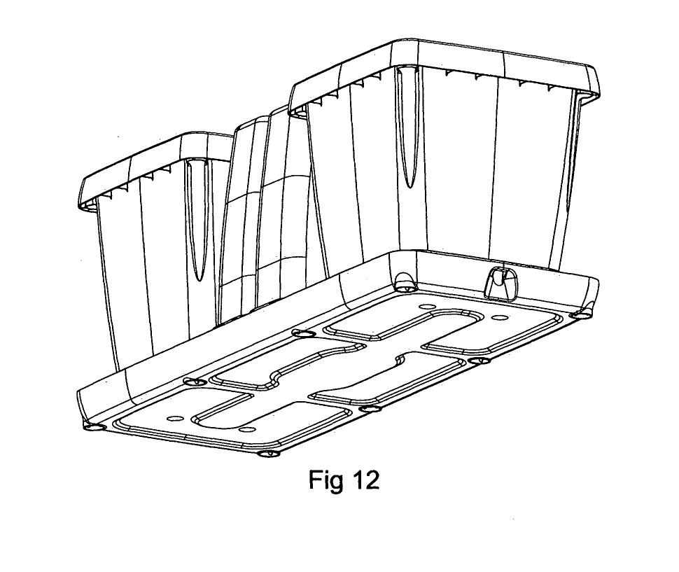

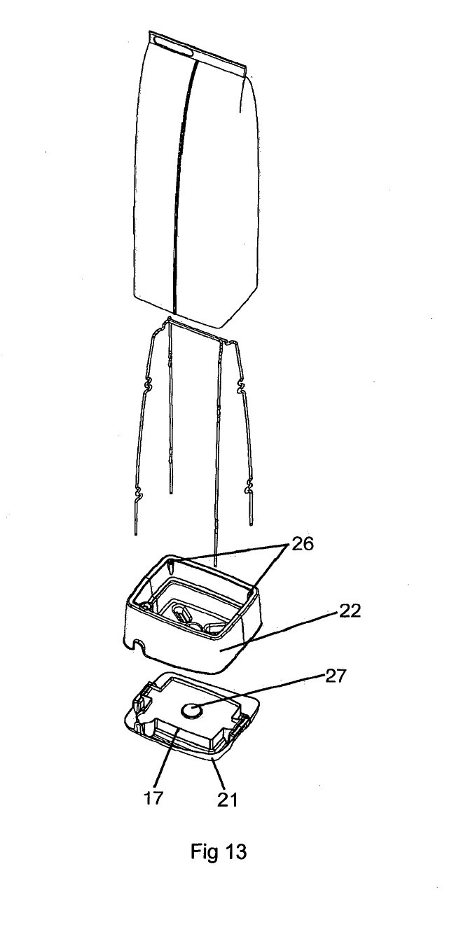

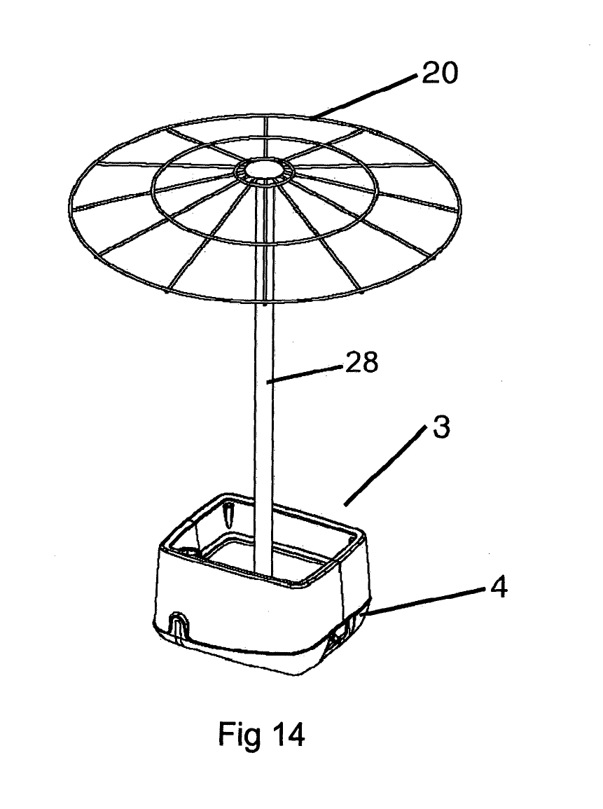

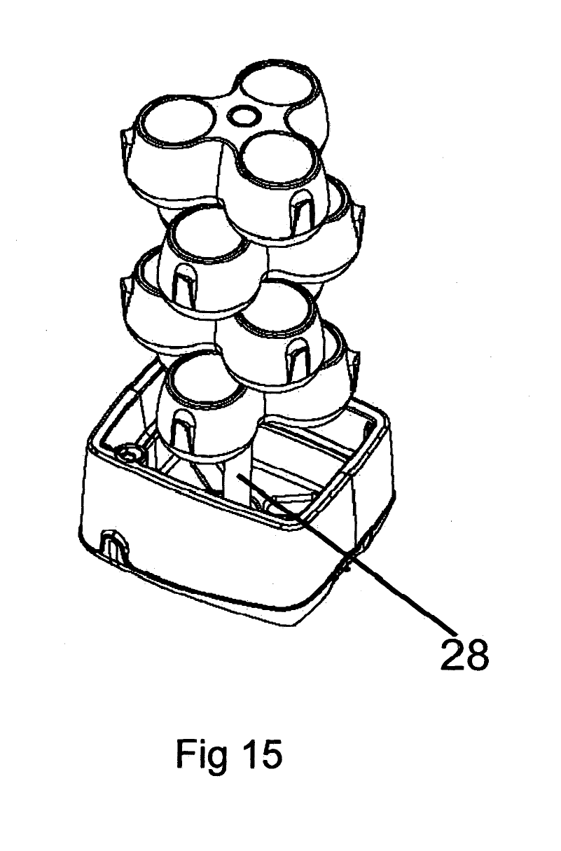

As evident to the skilled person, there are several possible applications as regards the disclosed system. As an example, the component (7) may include support elements for rods or stakes (26), which are positioned next to each vertex of the inner wall in the upper part of the said component and designed to support a greenhouse element; a fitting element (27), with a pyramidal shape, aimed at fixing the supporting tube and guide bar (28). Examples of this are the embodiments depicted in the FIGS. 11, 13 and 14.

In the previous description a liquid receiver is referred to. Obviously, the term liquid shall be understood mainly as water, but also as water with products which are commonly used for plant cultivation, such as fertilizers, herbicides, pesticides, etc.

### Caption

Modular integrated system (1);

Removable liquid receiver (2);

Dosing element (3);

Watertight platform for containing liquid (4);

Air feeding tube (5);

Water tube (6);

Component (7);

Drainage means (9);

Aerating means (10);

Plants container (11);

Receiver's filling nozzle (12);

Receiver's walls (13, 14);

Electronic box (15);

Bounce of the drainage means (16);

Irrigation channels (17);

Vertical window (18);

Groove (19);

Groove's tube (20);

Component (3 linked parts) (21);

Upper part of the component (7) (22);

Funnelled element (23);

I-shaped cloth (24);

Support element for rods or stakes (26);

Fitting element (27);

Supporting tube and guide bar (28).

1. A modular integrated system (1) for seeds germination, cultivation, planting, fertilizing and maintenance of plants, characterized in that it comprises:
a liquid receiver (2) which includes a dosing element (3) comprising two holes, respectively, one for the passage of the air feeding tube (5) to the receiver (2) and another one (6) for the discharge of liquid from the receiver (2) under the action of gravity,
a watertight platform (4) for containing liquid and which is supplied by the said liquid receiver;
wherein the regulation of the water flow from the receiver (2) is dictated by the difference in height between the air feeding tube (5) to the receiver and the tube (6) for the discharge of liquid under the action of gravity, i.e. the water will be discharged from the receiver (2) only and if the water level in the platform (4) is lower than the length of the tube (5);
at least one component (7) for fitting the liquid receiver (2) and/or for fitting at least one plant container;
an absorbing cloth at the bottom of the component (4);
drainage means (9) for removing the excess water from the platform (4); and
aerating means (10) for the platform (4) being comprised of holes positioned above the water line.

2. The integrated system (1), according to claim 1, characterized in that the tubes (5) and (6) are an integral part of the dosing element (3).

3. The integrated system (1), according to claim 1, characterized in that the tube (6) for the discharge of liquid under the action of gravity has its lower end bevelled.

4. The integrated system (1), according to claim 1, characterized in that the liquid receiver (2) is removable.

5. The integrated system (1), according to claim 4, characterized in that the dosing element (3) acts as the cover of the removable liquid receiver (2).

6. The integrated system (1), according to claim 1, characterized in that the liquid receiver is an integral part of the plants container (11) being formed in a double wall (13, 14) of the said container.

7. The integrated system (1), according to claim 1, characterized in that the drainage means (9) for removing the excess water from the platform (4) comprise at least a tubular bounce, which opens outwards, projecting upwards from the bottom of the platform (4), and whose height determines the maximum level of water in the above mentioned platform (4).

8. The integrated system (1), according to claim 1, characterized in that the watertight platform (4) is provided with a side groove (19) for the passage of a tube (20) with an absorbing cloth which is connected to another platform (4) in order to promote the transfer of liquid.

9. The integrated system (1), according to claim 1, characterized in that the removable liquid receiver (2) is provided with a vertical window (18) so that the liquid level inside it can be read.

10. The integrated system (1), according to claim 1, characterized in that the removable liquid receiver (2) includes a cover, this being also provided with a vertical window, which is overlapped with the vertical window (18) so that the liquid level inside the receiver (2) can be read.

11. The integrated system (1), according to claim 1, characterized in that the liquid receiver (2), the components (3) and the watertight platform (4) are manufactured in a moldable material.

12. The integrated system (1), according to claim 1, characterized in that the removable receiver (2) is undifferentiatedly fitted into one of the three parts (7).

13. The integrated system (1), according to claim 1, characterized in that the parts (7) are put together in order to form a single unit (21).

14. The integrated system (1), according to claim 13, characterized in that the part (21) includes funnelled elements (23) developing downwards, with a hole in the lower end for the platform (4), the said elements carrying an absorbing cloth.

15. The integrated system (1), according to claim 1, characterized in that the platform (4) and the parts (7) have a configuration whose shape is always suitable for assembling the latter into the platform.

16. The integrated system (1), according to claim 1, characterized in that the part (7) has a conic shape with a hole at its lower end.

17. The integrated system (1), according to claim 1, characterized in that the component (7) includes a part (22) that includes cavities for germination.

18. The integrated system (1), according to claim 1, characterized in that reducers are fitted into the relevant holes of the components (7, 3) so that containers of different sizes can be used.

19. The integrated system (1), according to claim 1, characterized in that the component (7) comprises:
four elements for supporting rods or stakes (26) which are positioned next to each vertex of the inner wall in the upper part of the said component;
a fitting element (27), with a pyramidal shape, aimed at fixing the supporting tube and guide bar (28).
